(19) United States
(12) Patent Application Publication
(10) Pub. No.: US 2004/0194882 A1
(43) Pub. Date: Oct. 7, 2004

(54) Method for disassembling a stacked-chip package

(76) Inventor: Ying-Hao Hung, Hsinchu Hsien (TW)

Correspondence Address: Keith Kline, PRO-TECHTOR INTERNATIONAL SERVICES, 20775 Norada Court, Saratoga, CA, 95070-3018, US

(21) Appl. No.: 10/409,276

(22) Filed: Apr. 7, 2003

(51) Int. Cl. B32B 1/00

(52) U.S. Cl. 156/344

(57) ABSTRACT

A method for disassembling a stacked-chip package includes the steps of: providing a corrosive onto glue above an upper chip to erode the glue and to expose the upper chip; supplying a heat source onto the upper chip to melt the glue and an adhesive of the stacked-chip package; and removing the upper chip to expose the lower chip. Thus, it is possible to disassemble the stacked-chip package in order to perform a failure analysis, to find the fault reasons, and to improve the package processes.

### BACKGROUND OF THE INVENTION

1. Field of the Invention

The invention relates to a method for disassembling a stacked-chip package, and in particular to a method for disassembling a package having stacked chips so as to perform a failure analysis and find fault reasons for the package.

2. Description of the Related Art

Referring to FIG. 1, a conventional stacked-chip package includes a substrate 10, a lower chip 12, a spacer 14, an upper chip 16 and a glue layer 18. The lower chip 12 is adhered to the substrate 10 and is electrically connected to the substrate 10 by a plurality of wires 20. The spacer 14 is adhered to the lower chip 12. The upper chip 16 is adhered to the spacer 14 and is also electrically connected to the substrate 10 by the plurality of wires 20. The glue layer 18 encapsulates the upper and lower chips 16 and 12 to complete the stacked-chip package.

After the stacked-chip package is completed, the package has to be tested. If the tested package has poor electrical connections or fails to work, the overall package has to be treated as a wasted material in the prior art. In this case, damage is caused and fault reasons cannot be found to improve the manufacturing processes. Therefore, it is an important subject to disassemble the stacked-chip package in order to perform a failure analysis and to find the fault reasons.

### SUMMARY OF THE INVENTION

An object of the invention is to provide a method for disassembling a stacked-chip package in order to perform a failure analysis and to find the fault reasons.

To achieve the above-mentioned object, the invention provides a method for disassembling a stacked-chip package. The method includes the steps of: providing a corrosive onto glue above an upper chip to erode the glue and to expose the upper chip; supplying a heat source onto the upper chip to melt the glue and an adhesive of the stacked-chip package; and removing the upper chip to expose a lower chip.

Thus, it is possible to disassemble the stacked-chip package in order to perform a failure analysis, to find the fault reasons, and to improve the package processes.

### BRIEF DESCRIPTION OF THE DRAWINGS

FIG. 1 is a schematic illustration showing a conventional stacked-chip package.

FIG. 2 is a first schematic illustration showing a method for disassembling a stacked-chip package according to an embodiment of the invention.

FIG. 3 is a second schematic illustration showing the method for disassembling the stacked-chip package according to the embodiment of the invention.

FIG. 4 is a third schematic illustration showing the method for disassembling the stacked-chip package according to the embodiment of the invention.

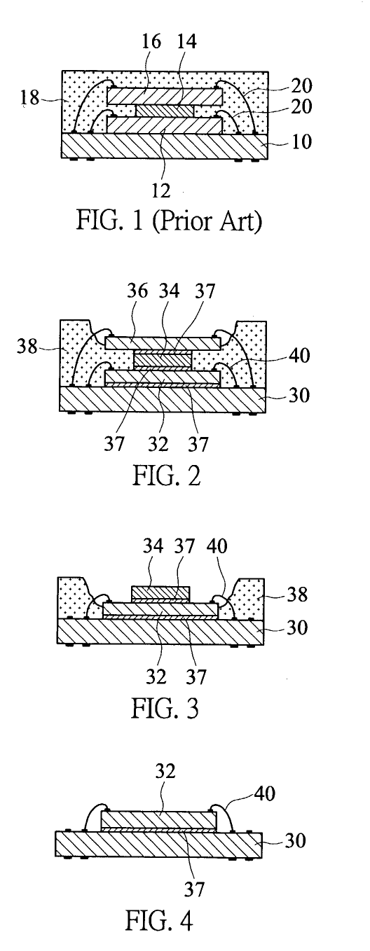

### DETAILED DESCRIPTION OF THE INVENTION

FIG. 2 is a first schematic illustration showing a method for disassembling a stacked-chip package according to an embodiment of the invention. In this embodiment, the stacked-chip package includes a substrate 30, a lower chip 32, a spacer 34, an upper chip 36 adhered to the lower chip 32 by an adhesive 37, and glue 38.

The adhesive 37 adheres the lower chip 32 to the substrate 30, and a plurality of wires 40 electrically connects the lower chip 32 to the substrate 30. The spacer 34 is adhered to the lower chip 32 and the upper chip 36 is adhered to the spacer 34 by the adhesive 37 to prevent the upper chip 36 from contacting the wires 40. Further, the plurality of the wires 40 also electrically connects the upper chip 36 to the substrate 30. The glue 38 encapsulates the upper chip 36 and the lower chip 32 to protect them.

After the stacked-chip package is completed, the package has to be tested. If the tested package has poor electrical connections or fails to work, it is possible to use the method of the invention to disassemble the stacked-chip package so as to perform a failure analysis, to find fault reasons for the package, and to improve the manufacturing processes.

Referring to FIG. 2 to FIG. 4, the method of the invention includes the following steps.

First, a corrosive is provided onto the glue 38 above the upper chip 36 in order to erode the glue 38 above the upper chip 36 and to expose the upper chip 36. The corrosive may be a sulfuric acid to effectively erode the glue 38 and to expose the upper chip 36.

Next, a proper heat source is supplied onto the upper chip 36 in order to melt the glue 38 and the adhesive 37. Then, the upper chip 36 and the spacer 34 may be removed. The heat source may be hot air from a hot air gun, and the hot air may have a temperature of above 200° C. The glue 38 and adhesive 37 may be melted by supplying the heat source for 5 to 10 seconds.

Thus, it is possible to easily disassemble the stacked-chip package in order to perform a failure analysis, to find the fault reasons, and to improve the package processes.

While the invention has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modifications.

What is claimed is:

1. A method for disassembling a stacked-chip package having a substrate, a lower chip, an upper chip adhered to the lower chip by an adhesive, and glue for encapsulating the upper and lower chips, the method comprising the steps of:
providing a corrosive onto the glue above the upper chip to erode the glue and to expose the upper chip;
supplying a heat source onto the upper chip to melt the glue and an adhesive of the stacked-chip package; and
removing the upper chip to expose the lower chip.

2. The method according to claim 1, wherein the corrosive is a sulfuric acid.

3. The method according to claim 1, wherein the heat source is hot air from a hot air gun.

4. The method according to claim 1, wherein the heat source has a temperature substantially equal to 200° C. and the heat source is supplied for substantially 5 to 10 seconds.
